(19) United States
(12) Patent Application Publication
(10) Pub. No.: US 2006/0041559 A1
(43) Pub. Date: Feb. 23, 2006

(54) Innovation for managing virtual storage area networks

(75) Inventors: Duane M. Baldwin, Mantorville, MN (US); Gary T. Axberg, Lake Elmo, MN (US); Surya Ghatty, Rochester, MN (US); Lisa A. Huston, Rochester, MN (US); David L. Merbach, Rochester, MN (US)

Correspondence Address: Frank C. Nicholas;CARDINAL LAW GROUP, Suite 2000, 1603 Orrington Avenue, Evanston, IL, 60201, US

(73) Assignee: International Business Machines Corporation, Armonk, NY (US)

(21) Appl. No.: 10/919,935

(22) Filed: Aug. 17, 2004

(51) Int. Cl. G06F 17/30; G06F 7/00

(52) U.S. Cl. 707/10

(57) ABSTRACT

An innovation for managing a virtual storage area network involves several processing stages. First, a logical portion of each network switch allocated to the virtual storage area network is discovered. Second, for each discovered network switch, a virtual switch is generated as a representation of the logical portion of the corresponding network switch. Third, the virtual storage area network is managed based on visual presentation(s) of the virtual switch(es).

### FIELD OF INVENTION

The present invention generally relates to the management of storage area networks. The present invention specifically relates to tools for managing virtual storage area networks within a storage area network.

### BACKGROUND OF THE INVENTION

FIG. 1 illustrates an exemplary storage area network 30 for allowing read and write access by a system administrator computer 10 and user computers 20-26 to storage subsystems 60-66. To this end, host computers 40-46 are coupled to system administrator 10 and users 20-26 via a conventional network (e.g., an internet or intranet) as shown in FIG. 1, and are further coupled to storage subsystems 60-66 via conventional network switches 50-52 (e.g., Cisco MDS 9000 Fabric Switches) as shown in FIG. 1. In operation, all read and write accesses by system administrator 10 and users 20-26 to storage subsystems 60-66 via hosts 40-46 are processed by network switches 50-52 to properly route each read/write access to the appropriate storage subsystem(s) 60-66.

One feature of network switches 50-52 is the ability to facilitate a creation of virtual storage area networks by system administrator 10 via hosts 40-46, such as, for example, virtual storage area networks (“VSANs”) 70, 80 and 90 as shown in FIG. 1. VSANs 70, 80 and 90 are logical storage area networks over the physical infrastructure of storage area network 30. In this example, VSAN 70 encompasses (1) hosts 40-42, (2) a host port HP1, a host port HP2, a network port NP1, a storage port SP1 and a storage port SP2 of network switch 50, (3) a host port HP3, a network port NP2, and a storage port SP3 of switch 51, and (4) storage subsystems 60-62.

VSAN 80 encompasses (1) hosts 43-45, (2) a host port HP4, a host port HP5, a network switch NP3 and a storage port SP4 of network switch 51, (3) a host port HP6, a network switch NP4 and a storage pot SP5 of network switch 52, and (4) storage subsystems 63 and 64.

And, VSAN 90 encompasses (1) host 46, (2) a host port HP7, a storage port SP6 and a storage port SP7 of network switch 52, and (3) storage subsystems 65 and 66.

Currently, storage area network manager modules and corresponding agents (e.g., IBM Tivoli Storage Area Network Manager and corresponding agents) are installed on system administrator 10 and host 40-46, respectively, to facilitate management of hosts 40-46, network switches 50-52 and storage subsystems 60-66 of storage area network 40 as shown in FIG. 1. Capabilities of such storage area network manager modules and corresponding agents include discovery, monitoring, availability and event management of resources within associated storage area network 30. However, one drawback is the current inability of storage area network manager modules and corresponding agents to discover and display the physical infrastructure of VSANs 70, 80 and 90.

### SUMMARY OF THE INVENTION

The present invention provides a new and unique innovation for the discovery and display of the physical infrastructure of a virtual storage area network to thereby facilitate a management of the virtual storage area network.

One form of the present invention is a signal bearing medium tangibly embodying a program of machine-readable instructions executable by a processor to perform operations for managing a virtual storage area network encompassing at least one network switch of a storage area network. The operations involve a discovery of a logical portion of a network switch allocated to the virtual storage area network, and a generation of a virtual switch as a representation of the logical portion of the network switch.

A second form of the present invention is computer employing a processor and a memory storing instructions operable with the processor to perform operations for managing a virtual storage area network encompassing at least one network switch of a storage area network. The instructions involve a discovery of a logical portion of a network switch allocated to the virtual storage area network, and a generation of a virtual switch as a representation of the logical portion of the network switch.

A third form of the present invention is a signal bearing medium tangibly embodying a program of machine-readable instructions executable by a processor to perform operations for managing a virtual storage area network encompassing at least one network switch of a storage area network. The operations involve a generation of a virtual switch as a representation of a logical portion of a network switch allocated to the virtual storage area network, and a facilitation of a management of the virtual storage area network based on a visual presentation of the virtual switch.

A fourth form of the present invention is computer employing a processor and a memory storing instructions operable with the processor to perform operations for managing a virtual storage area network encompassing at least one network switch of a storage area network. The instructions involve a generation of a virtual switch as a representation of a logical portion of a network switch allocated to the virtual storage area network, and a facilitation of a management of the virtual storage area network based on a visual presentation of the virtual switch.

The forgoing forms and other forms, features and advantages as well as features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

### BRIEF DESCRIPTION OF THE DRAWINGS

FIG. 1 illustrates an exemplary storage area network as known in the art;

FIG. 2 illustrates a flowchart representative of a VSAN management method in accordance with the present invention;

FIG. 3 illustrates an exemplary provision of one embodiment in accordance with the present invention of virtual switches in the virtual storage area networks illustrated in FIG. 1;

FIG. 4 illustrates an exemplary entity model showing the relationships between the storage area network, the virtual storage area networks and the virtual switches illustrated in FIG. 3;

FIG. 5 illustrates an exemplary visual presentation of virtual switches illustrated in FIG. 3 as encompassed in a hierarchy view of the storage area network illustrated in FIG. 3;

FIG. 6 illustrates an exemplary visual presentation virtual switches illustrated in FIG. 3 as encompassed in a topology view of a virtual storage area network illustrated in FIG. 3; and

FIG. 7 illustrates one embodiment of a computer in accordance with the present invention.

### DESCRIPTION OF THE PRESENT INVENTION

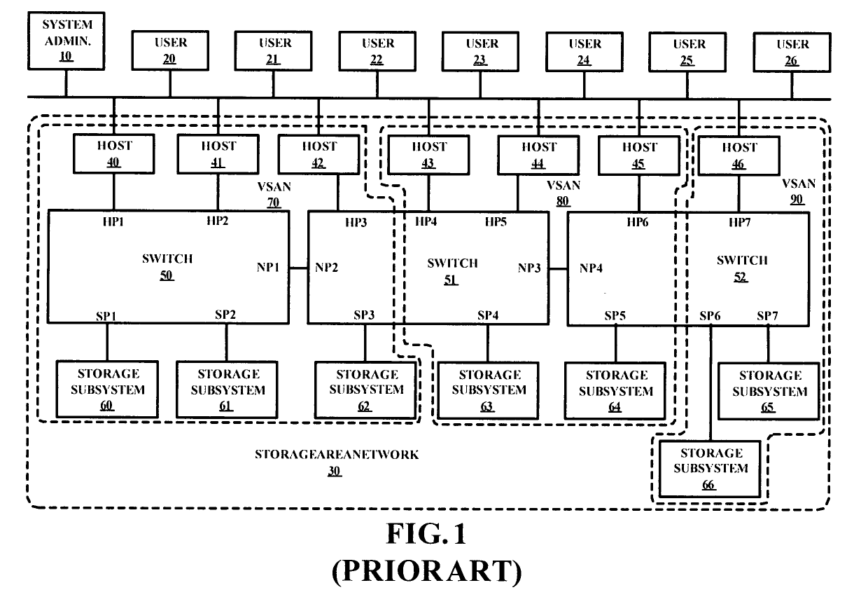

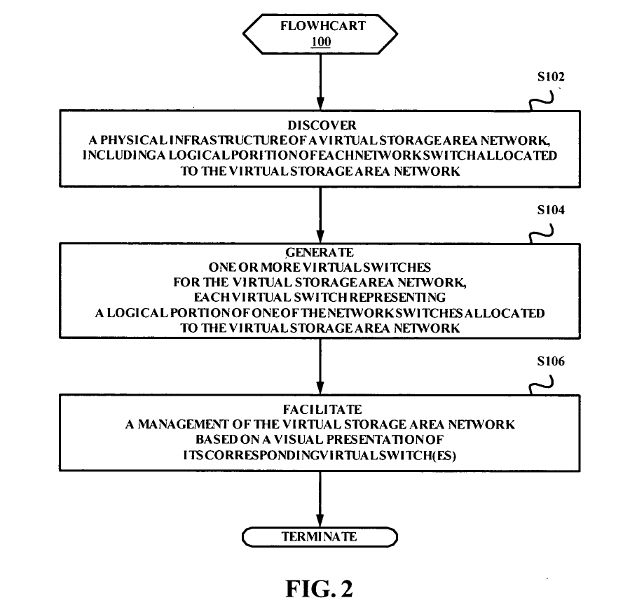

FIG. 2 illustrates a flowchart 100 representative of a virtual storage area management method of the present invention. To facilitate an understanding of the virtual storage area management method, each stage of flowchart 100 will be generally described as well as specifically described in the context of storage area network 30 (FIG. 1).

Referring to FIG. 2, a stage S102 of flowchart 100 involves a conventional discovery, full or topology, of a physical infrastructure of a virtual storage area network including each port of each network switch allocated to the virtual storage area network. Such discovery, in-band or out-band, can be triggered by a user discovery request, an occurrence of a discovery event (e.g., a change in the storage area network), a discovery schedule, a periodic discovery, and an addition of a storage area network manager modules and/or one or more corresponding agents.

In the context of storage area network 30, stage S102 involves several discoveries of host ports HP1-HP7 and storage ports SP1-SP7 of network switches 50-52 as illustrated in FIG. 1. One discovery is of the logical portion of network switch 50 allocated to VSAN 70, particularly ports HP1, HP2, NP1, SP1, and SP2 of network switch 50.

A second discovery is of the logical portion of network switch 51 allocated to VSAN 70, particularly ports HP3, NP2 and SP3 of network switch 51.

A third discovery is of the logic portion of network switch 51 allocated to VSAN 80, particularly ports HP4, HP5, NP3 and SP4 of network switch 51.

A fourth discovery is of the logical portion of network switch 52 allocated to VSAN 80, particularly ports HP6, NP4 and SP5 of network switch 52.

A final discovery is of the logical portion of network switch 52 allocated to VSAN 90, particularly ports HP7, SP6 and SP7 of network switch 52.

Referring again to FIG. 2, a stage S104 of flowchart 100 involves a generation of one or more virtual switches for the virtual storage area network with each virtual switch representing a logical portion of one of the network switches allocated to the virtual storage area network. In particular, each virtual switch is a collection of the port(s) of the associated network switch allocated to the virtual storage area network.

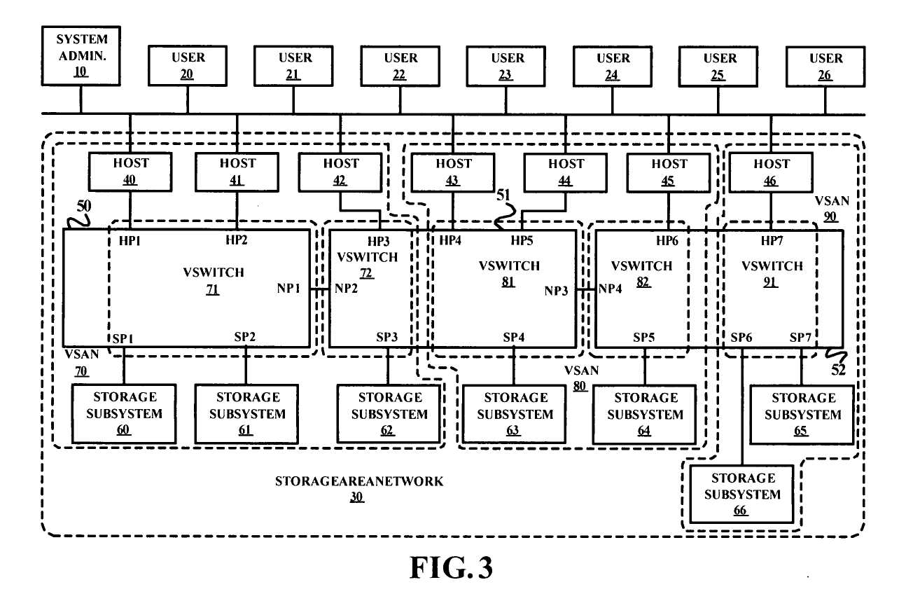

In the context of storage area network 30, stage S104 involves several generation of virtual switches as illustrated in FIG. 3. One generation is of a virtual switch (“VSWITCH”) 71 representing the discovered logical portion of network switch 50 allocated to VSAN 70, particularly ports HP1, HP2, NP1, SP1 and SP2 of network switch 50.

A second generation is of a VSWITCH 72 representing the discovered logical portion of network switch 51 allocated to VSAN 70, particularly ports HP3, NP2 and SP3 of network switch 51.

A third generation is of a VSWITCH 81 representing the discovered logical portion of network switch 51 allocated to VSAN 80, particularly ports HP4, HP5, NP3 and SP4 of network switch 51.

A fourth generation is of a VSWITCH 82 representing the discovered logical portion of network switch 52 allocated to VSAN 80, particularly ports HP6, NP4 and SP5 of network switch 52.

A final generation is of a VSWITCH 91 representing the discovered logical portion of network switch 52 allocated to VSAN 90, particularly ports HP7, SP6 and SP7 of network switch 52.

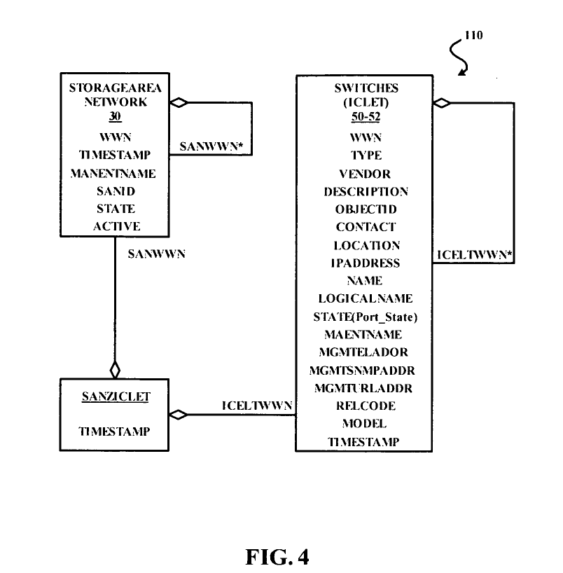

FIG. 4 illustrates an entity model 10 of storage area network 30. In entity model 110, SANWWN and ICELTWWN show the conventional relationship of storage area network 30 and network switches 50-52. Additionally, SANWWN** references to a logical storage area network (i.e., a VSAN) within storage area network 30, and ICELTWWN references to a logical network switch (i.e., a VSWITCH) within physical network switches 50-52. Those having ordinary skill in the art will appreciate that entity model 110 is indicative of a full complement of network switching functions being allocated to each logical network switch by it corresponding network switch whereby each logical storage area network is a fully functional storage area network.

Referring again to FIG. 2, a stage S106 of flowchart 100 involves one or more visual presentations of the generated VSWITCH(es) during stage S104 to facilitate a management of the corresponding VSAN(s). The visual presentation(s) can be presented in any form with any degree of graphical user interface complexity to facilitate the management of the corresponding VSAN(s).

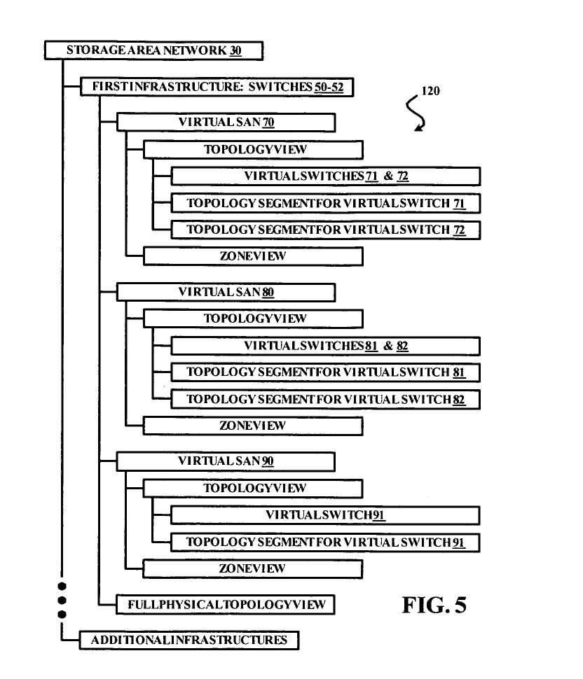

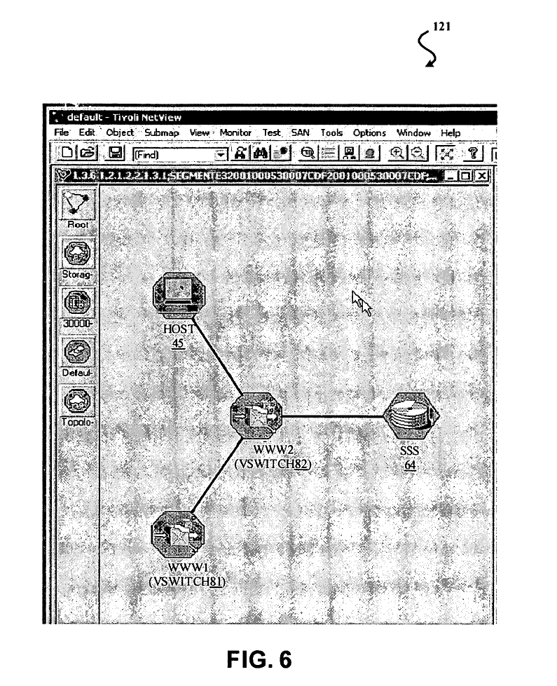

In the context of storage area network 30, stage S104 involves a visual presentation of VSWITCHes 71, 72, 81, 82 and 91 to facilitate a management of VSANs 70, 80 and 90, respectively. In one embodiment, a visual presentation in the form of a hierarchy view 120 of storage area network 30 as illustrated in FIG. 5 enables an understanding of all of the attributes and connections associated with VSANs 70, 80 and 90 as would be appreciated by those having ordinary skill in the art. In another embodiment, a visual presentation in the form of one topology view 121 of VSAN 80 (FIG. 3) as illustrated in FIG. 6. For topology view 121, an identifier WWW1 to a property window for VSWITCH 81, and an identifier WWW2 to a property window for VSWITCH 82.

Flowchart 100 is either terminated upon completion of stage S106 as shown in FIG. 2 to await a triggering of stage S102. Those having ordinary skill in the art will appreciate that an execution of flowchart 100 provides all of the management capabilities for a network switch (e.g., network switches 50-52 shown in FIGS. 1 and 3) to each VSWITCH (e.g., VSWITCHes 71, 72, 81, 82 and 91 shown in FIG. 3) including, but not limited to, graphical state indication, event monitoring, and switch and port properties. In addition, a network switch identifier (e.g., WWW) for each VSWITCH is provided, and an error detection/fault isolation can be performed at the VSAN and WSWITCH levels.

Those of ordinary skill in the art will further appreciate that, in practice, a structural implementation of flowchart 100 (FIG. 2) will vary depending on the specific implementation of a device or system embodying the present invention. Thus, the variety of hardware platforms and software environments for structurally implementing flowchart 100 is without limit.

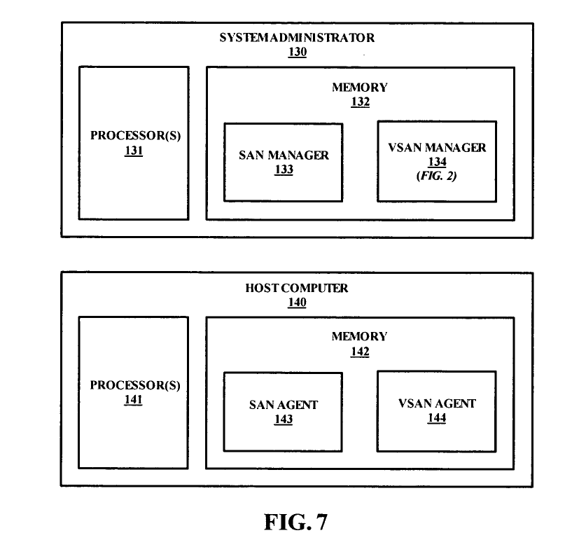

In one exemplary embodiment, a system administrator computer 130 as illustrated in FIG. 7 employs one or more conventional processors 131 and a conventional memory 132 (e.g., a ROM, hard drive, firmware, etc.) for storing computer instructions in a conventional SAN manager 133 (e.g., IBM Tivoli Storage Area Network Manager), and a VSAN manager 134 programmed in accordance with flowchart 100 (FIG. 2). As such, processor(s) 131 can be operated to execute a conventional operating system to control program execution of the computer instructions of managers 133 and 134. In practice, VSAN manager 134 will typically be a subroutine of SAN manager 133.

Also by example, a host computer 140 as illustrated in FIG. 7 employs one or more conventional processors 141 and a conventional memory 142 (e.g., a ROM, hard drive, firmware, etc.) for storing computer instructions in a conventional SAN agent 143 associated with SAN manager 133, and a VSAN agent 144 associated with VSAN manager 134. As such, processor(s) 141 can be operated to execute a conventional operating system to control program execution of the computer instructions of agents 143 and 144. In practice, VSAN agent 144 typically will not be integrated with SAN agent 143.

From the description of computers 130 and 140 as illustrated in FIG. 7, those having ordinary skill in the art will appreciate hardware components, conventional or otherwise, in addition to the illustrated processors and memories that are necessary for a fully functional computer for managing VSANs within a SAN Those having ordinary skill in the art will furthermore appreciate various software languages that can be employed in writing software code for illustrated managers and agents of the present invention as well as an operating system and other programs that are necessary for a fully functional computer for managing VSANs within a SAN.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

We claim:

1. A signal bearing medium tangibly embodying a program of machine-readable instructions executable by a processor to perform operations for managing at least one virtual storage area network encompassing at least one network switch of a storage area network, the operations comprising:
discovering a first logical portion of a first network switch allocated to a first virtual storage area network, and
generating a first virtual switch as a representation of the first logical portion of the first network switch.

2. The signal bearing medium of claim 1, wherein the first logical portion of the first network switch includes each port of the first network switch allocated to the first virtual storage area network.

3. The signal bearing medium of claim 1, wherein the operations further comprise:
facilitating a management of the first virtual storage area network based on a visual presentation of the first virtual switch.

4. The signal bearing medium of claim 3, wherein facilitating the management of the first virtual storage area network based on the visual presentation of the first virtual switch includes graphically displaying a hierarchy view of the storage area network.

5. The signal bearing medium of claim 3, wherein facilitating the management of the first virtual storage area network based on the visual presentation of the first virtual switch includes graphically displaying a topology view of the first virtual storage area network.

6. The signal bearing medium of claim 1, wherein the operations further comprise:
discovering a second logical portion of the second network switch allocated to the first virtual storage area network, and
generating a second virtual switch as a representation of the second logical portion of the second network switch.

7. The signal bearing medium of claim 1, wherein the operations further comprise:
discovering a second logical portion of the first network switch allocated to a second virtual storage area network, and
generating a second virtual switch as a representation of the second logical portion of the first network switch.

8. A computer, comprising:
at least one processor; and
a memory storing instructions operable with the at least one processor for managing at least one virtual storage area network encompassing at least one network switch of a storage area network, the instructions being executed for:
discovering a first logical portion of a first network switch allocated to a first virtual storage area network; and
generating a first virtual switch as a representation of the first logical portion of the first network switch.

9. The computer of claim 8, wherein the first logical portion of the first network switch includes each port of the first network switch allocated to the first virtual storage area network.

10. The computer of claim 8, wherein the instructions further include:
facilitating a management of the first virtual storage area network based on a visual presentation of the first virtual switch.

11. The computer of claim 10, wherein facilitating the management of the first virtual storage area network based on the visual presentation of the first virtual switch includes graphically displaying a hierarchy view of the storage area network.

12. The computer of claim 10, wherein facilitating the management of the first virtual storage area network based on the visual presentation of the first virtual switch includes graphically displaying a topology view of the first virtual storage area network.

13. The computer of claim 8, wherein the instructions further include:
discovering a second logical portion of the second network switch allocated to the first virtual storage area network, and
generating a second virtual switch as a representation of the second logical portion of the second network switch.

14. The computer of claim 8, wherein the instructions further include:
discovering a second logical portion of the first network switch allocated to a second virtual storage area network, and
generating a second virtual switch as a representation of the second logical portion of the first network switch.

15. A signal bearing medium tangibly embodying a program of machine-readable instructions executable by a processor to perform operations for managing at least one virtual storage area network encompassing at least one network switch of a storage area network, the operations comprising:
generating a first virtual switch as a representation of a first logical portion of the first network switch allocated to a first virtual storage area network; and
facilitating a management of the first virtual storage area network based on a visual presentation of the first virtual switch.

16. The signal bearing medium of claim 15, wherein the first logical portion of the first network switch includes each port of the first network switch allocated to the first virtual storage area network.

17. The signal bearing medium of claim 15, wherein facilitating the management of the first virtual storage area network based on the visual presentation of the first virtual switch includes graphically displaying a hierarchy view of the storage area network.

18. The signal bearing medium of claim 15, wherein facilitating the management of the first virtual storage area network based on the visual presentation of the first virtual switch includes graphically displaying a topology view of the first virtual storage area network.

19. The signal bearing medium of claim 15, wherein the operations further comprise:
generating a second virtual switch as a representation of the second logical portion of a second network switch allocated to the first virtual storage area network; and
facilitating a management of the first virtual storage area network based on a visual presentation of the second virtual switch.

20. The signal bearing medium of claim 15, wherein the operations further comprise:
generating a second virtual switch as a representation of a second logical portion of the first network switch allocated to a second virtual storage area network; and
facilitating a management of the second virtual storage area network based on a visual presentation of the second virtual switch.

21. A computer, comprising:
at least one processor; and
a memory storing instructions operable with the at least one processor for managing at least one virtual storage area network encompassing at least one network switch of a storage area network, the instructions being executed for:
generating a first virtual switch as a representation of a first logical portion of the first network switch allocated to a first virtual storage area network; and
facilitating a management of the first virtual storage area network based on a visual presentation of the first virtual switch

22. The computer of claim 21, wherein the first logical portion of the first network switch includes each port of the first network switch allocated to the first virtual storage area network.

23. The computer of claim 22, wherein facilitating the management of the first virtual storage area network based on the visual presentation of the first virtual switch includes graphically displaying a hierarchy view of the storage area network.

24. The computer of claim 22, wherein facilitating the management of the first virtual storage area network based on the visual presentation of the first virtual switch includes graphically displaying a topology view of the first virtual storage area network.

25. The computer of claim 21, wherein the instructions further include:
generating a second virtual switch as a representation of the second logical portion of a second network switch allocated to the first virtual storage area network; and
facilitating a management of the first virtual storage area network based on a visual presentation of the second virtual switch.

26. The computer of claim 21, wherein the instructions further include:
generating a second virtual switch as a representation of a second logical portion of the first network switch allocated to a second virtual storage area network; and
facilitating a management of the second virtual storage area network based on a visual presentation of the second virtual switch.
